(19) United States
(12) Patent Application Publication
(10) Pub. No.: US 2012/0311929 A1
(43) Pub. Date: Dec. 13, 2012

(54) APPARATUS AND METHOD FOR CULTIVATING ONE OR MORE PLANTS

(76) Inventors: Kamal DAAS, Bergschenhoek (NL); Talal DAAS, Naperville, IL (US); Peter VAN DER DRIFT, Bleiswiik (NL)

(21) Appl. No.: 13/396,808

(22) Filed: Feb. 15, 2012

(30) Foreign Application Priority Data
Feb. 16, 2011 (DE) 20 2011 002 791.0

(51) Int. Cl. A01G 9/02; A01D 45/00; A01G 1/00

(52) U.S. Cl. 47/65.8; 47/66.5; 47/66.3; 47/58.1 R

(57) ABSTRACT

The present invention relates to an apparatus for cultivating one or more plants, wherein the apparatus has at least one first chamber and at least one second chamber which are separated from one another by at least one first partition wall, wherein the inner spaces of the first chamber and of the second chamber are connected by one or more connection openings in the first partition wall, and wherein the first partition wall is made movable and/or is arranged so that the size of the first chamber and/or of the second chamber is changeable.

The invention relates to an apparatus for cultivating one or more plants as well as to a method for cultivating one or more plants.

Apparatus and methods for the commercial cultivation of plants, in particular crop plants, are known in the prior art.

It is a goal of the invention to provide an apparatus which allows an improved cultivation of plants and in particular of crop plants bearing a crop.

This object is achieved by an apparatus having the features of claim 1.

Provision is accordingly made that the apparatus has at least one first chamber and at least one second chamber which are separated from one another by at least one first partition wall, wherein the inner spaces of the first chamber and of the second chambers are connected by one or more connection openings in the first partition wall, and wherein the first partition wall is made movable and/or is arranged so that the size of the first chamber and/or of the second chamber is changeable.

It is possible by the design of the apparatus in accordance with the invention to take the fact into account that the space requirements of a plant or in particular of a crop plant change over the course of time.

If, for example, crop is formed, such as potatoes or the like, the corresponding chamber can be enlarged by the movably made partition wall so that the space available for the crop becomes larger and the crop yield increases overall.

The term “movable” is to be understood as any desired case which includes a change in position of the partition wall. The change in position can, for example, be a movement of the partition wall in part or in full, for example by pivoting, displacing, relocating, etc. A movement of the partition wall can, however, also be achieved in that the partition wall is flexible and in particular yielding or elastically or plastically deformable and thereby likewise enables a volume change of the adjacent chambers.

The partition wall can thus, for example, be made as rigid or also as flexible.

Provision is made in a further embodiment of the invention that the second chamber has one or more outlet openings which are arranged in at least one second partition wall which bounds the second chamber at least regionally, preferably at its upper side. This second partition wall can thus, for example, form an upper cover of the apparatus. It is conceivable that a stem or the like of the plant projects through these outlet openings and that the leaves of the plant form or are located above the outlet opening, i.e. above the second partition wall, and the crop beneath the second partition wall. It is further conceivable that the root region of the plant is located in the first chamber which is separated at least partly by the first partition wall.

Provision is made in a further embodiment of the invention that the first partition wall is arranged or formed such that it is pivotable or bendable or movable in another manner.

Provision can furthermore be made that the first partition wall is connected to a separator which is preferably furthermore connected to a section of the apparatus which is located beneath the first partition wall and/or can also represent a separator of the chambers from one another. The cover can thus also be made in an areal fashion so that the term “cover” can be understood, for example, as an areal or plate-like element. The use of a flexible material for the named cover is conceivable.

The cover preferably has a size in the longitudinal direction of the apparatus which substantially corresponds to that of the apparatus itself, that therefore the cover preferably forms a separator or a further partition wall between the first and second chambers along the total length of the inner space of the apparatus. In this embodiment of the invention, provision is thus made that the first partition wall together with the separator forms a wall which overall separates the first chamber from the second chamber.

The named separator can be formed by a component which differs from the first partition wall, with in this case the first partition wall and the separator preferably being releasably or unreleasably connected to one another. It is, however, also conceivable that the partition wall and the separator are made in one piece, i.e. comprise one piece overall so that therefore the first partition wall and the cover form integral components of a common component which separates the two chambers from one another.

Provision is made in a further embodiment of the invention that the apparatus has at least one first side wall and/or at least one second side wall which preferably form outer surfaces of the apparatus. They can be made from one piece, i.e. form components of a one-part part, or also from a plurality of elements which can be indirectly or directly connected to one another in a suitable manner.

The first and/or the second side wall can comprise a flexible material and/or at least one dimension, preferably its height and/or length and/or width can be changeable. This first and/or second side wall can form a or the lateral outer walls of the apparatus.

It is conceivable to form this first and/or second side wall from a film or from a band or fabric or from any other material, preferably from plastic, which can be rolled up or wound up.

This named separator can have the object, on the one hand, of stabilizing or supporting the first partition wall in its position. In this case, the separator has the function of a supporting element.

Alternatively or additionally, provision can be made that the separator has the function of separating the first chamber from the second chamber, and indeed in a region in which this separation is not already provided by the first partition wall. The first partition wall together with the separator can thus largely or completely separate the first chamber from the second chamber. A further wall of the first chamber as well also of the second chamber can then be formed by respective outer walls or side walls as well as also by the second partition wall of the apparatus.

It is conceivable that the first partition wall and the separator are provided as two separate components which are connected to one another in a suitable manner (releasably or unreleasably, in a force locked or a shaped matched manner or with material continuity).

However, the case is also included by the invention that the first partition wall and the separator are integral elements of a common component.

In a preferred embodiment of the invention, the separator is flexible so that it allows the movement in accordance with the invention of the first partition wall.

Provision is made in a further embodiment of the invention that the apparatus has at least one first side wall which comprises a flexible material and/or whose height and/or length and/or width is variable. This first side wall can serve as an outer wall and thus form a boundary of the first and/or second chambers.

The first and/or the second side wall(s) preferably comprise(s) a film or other material which can be wound up or rolled up. This embodiment of the side wall likewise allows a volume change of the chamber which is adjacent to the side wall. It is thus conceivable, for example, that the named first and/or second side wall(s) comprise(s) a wound up material or a material which can be wound up such as a plastic film or the like and can, as required, be wound off from or onto a roll which is arranged at the apparatus in a suitable manner so that a change in the height of the side wall and thus also of the volume of the adjacent chamber(s) is possible.

Provision is made in a further embodiment of the invention that the apparatus has at least one second side wall which can form the second outer wall of the apparatus. The two side walls can be connected to one another in a suitable manner so that overall a closed space results which is formed by the two side walls as well as by the first and/or second partition wall(s). The first partition wall as well as the named separator can then be located within this space.

The first and/or the second side wall(s) can comprise a material which exerts a supporting or stabilizing function, for example a solid or rigid material.

It is also possible that a part of the outer wall of the apparatus is formed by a section of the first partition wall.

Provision is made in a further embodiment of the invention that at least one plant is arranged in the apparatus such that the roots of the plant are located exclusively or predominantly in the first chamber and the region of the plant bearing the fruit is located exclusively or predominantly in the second chamber.

Provision can furthermore be made that at least one plant is arranged in the apparatus such that a container or anther holder for fixing the plant is located in the at least one connection opening of the first partition wall. Soil or another substrate can be arranged in this container or holder, for example. Provision is preferably made that the roots extend in one direction and a stem or a region of the plant bearing the crop extends in the other direction from the container or holder.

Provision is made in a further embodiment of the invention that at least one plant is arranged in the apparatus such that the stem of the plant extends through the at least one outlet opening of the second partition wall and the leaves of the plant are located at least in part above the second partition wall and outside the second chamber.

A further cover such as a glass cover or plastic cover which is permeable to light can then preferably be provided as required above this second partition wall.

Provision can furthermore be made that water and/or nutrients are present in the first and/or second chamber(s) and/or that means are provided such as pipelines, hoses or nozzles or the like by means of which the first and/or the second chamber(s) can be supplied with water and/or nutrients.

The second chamber, which preferably serves the reception of the crop region or of the crop of the plant, can extend at least regionally above and/or next to the first chamber.

Provision is made in a further embodiment of the invention that the apparatus has an elongate extension. It should be understood by this that the apparatus is made larger in a first dimension, i.e. in the longitudinal direction, than in the other directions, i.e. than in the width direction and vertical direction.

The present invention furthermore relates to an arrangement including a plurality of apparatus for cultivating one or more plants, in particular in accordance with one of the claims 1 to 14, wherein the apparatus are arranged so that their spacing from one another is changeable. This embodiment has the advantage that the harvester or another user has the possibility of moving two apparatus away from one another to be able to move into the space between the two apparatus and to carry out the measures required such as harvesting or a treatment of the plant or the like. Subsequently the user can move the apparatus together again.

These movements can take place manually or mechanically or in an automated manner, e.g. by means of a motor.

It is conceivable that apparatus are arranged next to one another, and indeed such that the spacing of the side walls of two adjacent apparatus with respect to one another can be increased and reduced. It is thus conceivable, for example, that every individual apparatus comprises an elongate element and that these elongate elements are arranged parallel, or at least substantially parallel, to one another, wherein the spacing of at least two of these elements or apparatus from one another can be enlarged and/or reduced.

Provision can furthermore be made that the apparatus are connected to a suspension, wherein the suspension is designed so that the spacing of the apparatus or of the rows from one another is changeable and/or that the apparatus are connected to a support structure, in particular to rollers, rails, guides or the like, which are designed such that the spacing of the apparatus or of the rows from one another is changeable.

The present invention furthermore relates to a method of cultivating one or more plants in an apparatus in accordance with one of the claims 1 to 14 or in an arrangement in accordance with one of the claims 15 to 17 comprising the step-wise or continuous enlargement of the volume of the second chamber.

It is conceivable that the enlargement of the volume of the second chamber takes place by changing the position of the first partition wall.

The present invention finally relates to a method of harvesting the crop of one or more plants in an apparatus in accordance with one of the claims 1 to 14 or in an arrangement in accordance with one of the claims 15 to 17 comprising the step of the at least sectional pivoting, displacing, opening or removing of at least one boundary surface of the second chamber and the removal of the crop from the second chamber, wherein this step is preferably preceded by the enlargement of the spacing of at least two adjacent apparatus.

Further details and advantages of the invention will be explained in more detail with reference to an embodiment shown in the drawing.

There are shown:

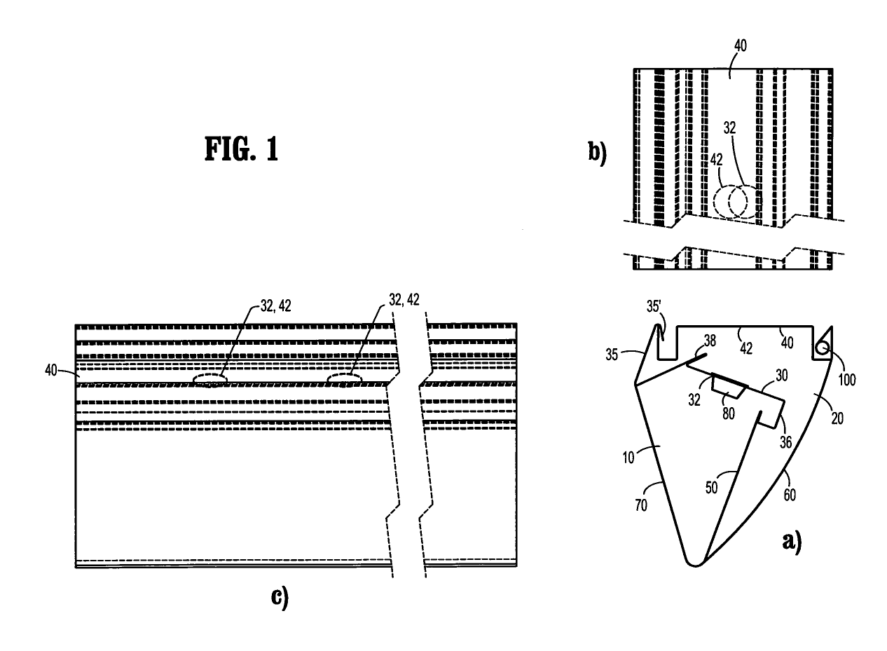

FIG. 1: a cross-sectional view of the apparatus in accordance with the invention as well as a plan view and a side view;

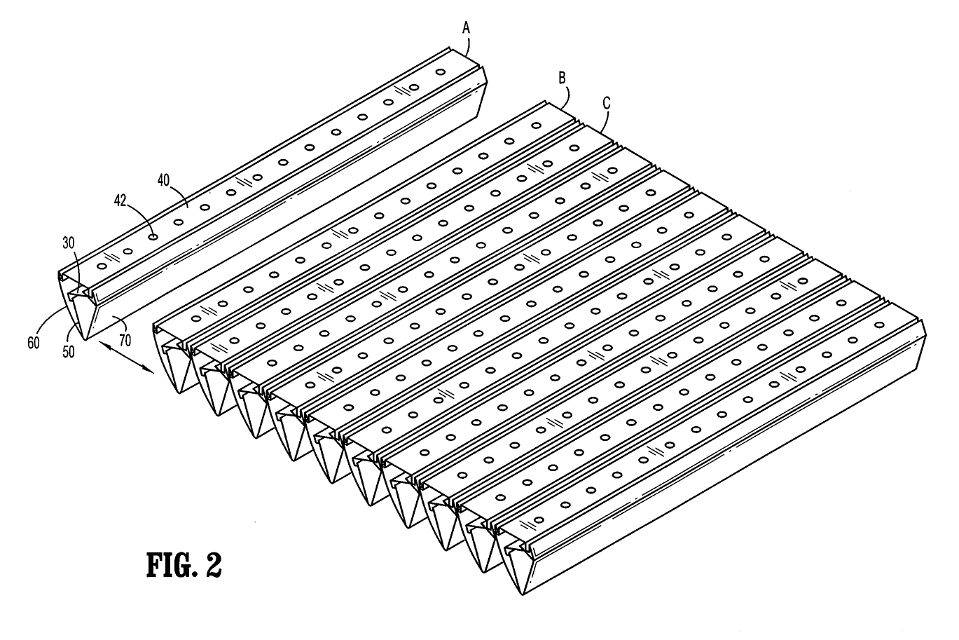

FIG. 2: a perspective representation of a plurality of apparatus in accordance with the invention next to one another; and

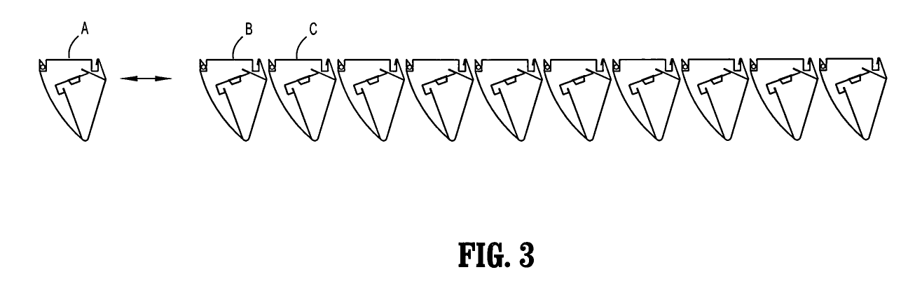

FIG. 3: a sectional representation through the arrangement in accordance with FIG. 2.

FIG. 1a shows a cross-sectional view through the apparatus in accordance with the invention.

The apparatus has a first chamber 10 and a second chamber 20. In this respect, the first chamber 10 is separated from the second chamber 20 by a first partition wall 30 as well as by a separator 50. A first side wall which is adjacent to the second chamber 20 is marked by the reference numeral 60 and a second side wall which is adjacent to the first chamber 10 is marked by the reference numeral 70.

As can be seen from this FIG. 1a, openings 32 are located in the first partition wall 30 which are spaced apart from one another in the longitudinal direction of the apparatus and which serve the reception of a container or other holder 80 for fixing a plant, not shown.

The upper boundary of the apparatus is formed by the second partition wall 40 which extends substantially horizontally in the embodiment or has a horizontally extending section. This second partition wall 40 has in its two marginal regions reception regions which are formed in U shape in the example shown here.

As can further be seen from FIG. 1a, a lateral limb 35 of the first partition wall 30 or of the second partition wall 70 engages with a bent-over section 35′ over the outer limb of the U-shaped reception region and is thus fixed or hung at the second partition wall 40 in a shape matched manner.

A U-shaped reception region is likewise located on the oppositely disposed side of the second partition wall 40. In the embodiment shown here, a roll 100 is located in it on which a plastic film or another film or web is rolled up which forms the first side wall 60. The material of the side wall 60 can thus be wound up and rolled off so that the height of the first side wall 60 is changeable.

The first side wall 60 thus preferably comprises a flexible material.

The second side wall 70 can likewise comprise a flexible or also a rigid material.

Both side walls 60, 70 are connected to one another in the lower end region of the apparatus. The lower section of the cover 50 also ends in this region.

The cover 50 comprises a flexible material such as plastic or the like.

The flexible cover 50 is connected in its upper end region to a backfolded region of the limb 36 of the first partition wall 30, as can be seen from FIG. 1a. This limb or region 36 is located on the other side of the partition wall 30 to the limb or region 35 with which the first partition wall 30 is connected to the second partition wall 40, e.g. in a shape-matched manner or also in a force-fit manner or with material continuity.

The first chamber 10 of the apparatus is thus formed or bounded by the first partition wall 30, the separator 50 and the second side wall 70. The second chamber 20 is likewise bounded by the first partition wall 30, the separator 50, the first side wall 60 and the second partition wall 40.

A section of the first partition wall 30 is marked by the reference numeral 38 in which two part regions of the first partition wall 30 lie over one another. This section thus has a 180° backfold of the first separation wall 30. An angle<180° is also conceivable for this section of the first partition wall 30.

Relative to this section 38, the region of the first partition wall 30 shown at the right thereof is pivotable upwardly and downwardly so that a change in the volume of the first chamber 10 or in the second chamber 20 results depending on the position of the first partition wall 30.

The region of a crop plant, not shown, in which the crop such as potatoes or the like grow is located above the container 80 or in the region of the second chamber 20. In particular the root region of the plant is located beneath the container 80, i.e. in the first chamber 10. The region of the plant which bears the leaves is located above the second partition wall 40 which is provided with outlet openings 42.

The region 20 can be selected as relatively small in a young growth stage of the plant since fruit or crop is not yet present at the plant.

In the course of the formation of the crop, the first partition wall 30 can moved or pivoted downwardly manually, automatically or also by the plant itself or by its enlarged space requirements in accordance with FIG. 1a so that an enlargement of the second chamber 20 results. The first partition wall 30 can be designed so that, after a movement into a different position, it maintains this position and does not spring back.

Alternatively or additionally to this, it is possible to roll off further material from the roll 100 for the first side wall 60 so that an enlargement of the second chamber 20 can also hereby be achieved.

The spacing between the first partition wall 30 and the second partition wall 40 is thus adjustable by the movability of the first partition wall 30.

As stated, the crop and/or offshoots, stolons, aerial roots, etc. are preferably located in the second chamber 20 and the root region of the plant is preferably located in the first chamber 10.

Means for supplying water, nutrients, etc. are preferably located in the first chamber 10. When the apparatus is in use, water or an air/water mixture or moistened air and/or air enriched with nutrients or a mixture of nutrients and/or water and/or air etc. are thus, for example, located in the first chamber 10.

Air is preferably located in the second chamber 20. Here, too, however, a moistening or a supply of nutrients is conceivable, for which purpose means can be provided which are not shown in the drawing.

FIG. 1b shows the apparatus in a plan view and illustrates the arrangement of the outlet openings 42 in the second partition wall 40 as wells the opening 32 of the first partition wall 30 disposed offset therebelow. FIG. 1c shows the arrangement in accordance with FIG. 1a in a side view and illustrates that the apparatus has an elongate extent, i.e. an extent in the depth direction in FIG. 1a.

In FIG. 1c, the openings 32, 42 of the first or second separation walls can be seen, with both the outlet openings 42 and the openings 32 of the first partition wall 30 being arranged spaced apart from one another and next to one another in the longitudinal direction of the apparatus.

FIG. 2 shows an arrangement of a plurality of the named apparatus in accordance with FIG. 1 next to one another. As can be seen from FIG. 2, the apparatus are formed substantially trough-like in cross-section and have an elongate form.

In the view shown in FIG. 2, the apparatus are arranged parallel to one another.

As can further be seen from FIG. 2, the outlet openings 42 of the second partition wall 40 are spaced apart from one another in the longitudinal direction of the apparatus, with this spacing being able to take place regularly or irregularly.

The spacing of the apparatus from one another can be changed by a system, not shown in more detail, at which the apparatus in accordance with FIG. 2 are suspended or run. This is indicated by a double arrow in FIG. 2. If therefore a user should want to harvest the crop from the apparatus B, he increases the spacing between the adjacent apparatus A and B and then, for example, opens the first side wall 60 by removing the roll 100 from the cut-out of the second partition wall or by cutting open or removing or displacing the first side wall 60, whereby the apparatus is accessible from the side. In this case, the crop can be easily harvested. Subsequently, the roll 100 can again be inserted, whereby the apparatus is closed again.

It is thus generally possible to design the apparatus so that they are accessible from a side so that the harvesting procedure can take place from this side. It is also possible and covered by the invention to design the apparatus so that this applies to both sides, that therefore an accessibility takes place from both sides so that harvesting can also be carried out from both sides.

It is advantageous in this connection if the second chamber 20, which predominantly or exclusively contains the crop, is also located at least partly to the side of the first chamber 10. This results, for example, from FIG. 1a. It can be seen from this that the second chamber 20 is located partly above and partly next to the first chamber 10.

It must furthermore be pointed out at this point that in the embodiment in accordance with FIG. 1 the first partition wall 30 extends at an acute angle to the horizontal.

It is equally conceivable and also covered by the invention that the first partition wall 30 adopts a horizontal position or also has a larger inclination than shown in FIG. 1a, for example pivoted relative to the horizontal by an angle of 45° or also more. The converse case of an inclination of the first partition wall 30 relative to the horizontal of 45° or less, as shown in FIG. 1a, is also covered by the invention and is naturally likewise conceivable.

If the user has harvested the content of the apparatus in accordance with B in accordance with FIG. 2, he can again reduce the spacing between the apparatus A and B in that the apparatus B is moved toward the apparatus A, whereby the spacing between the apparatus B and C enlarges in order then to be able to harvest the apparatus C.

It is possible in this manner to provide a compact field overall or to provide an areally compact region of apparatus. The area required overall is hardly larger than the area taken up by the apparatus themselves since basically in each case only a spacing is required to be able to carry out a harvesting procedure. In other words, this means that not all apparatus have to be spaced apart from one another, but that rather the only spacing or also a plurality of spacings is/are only provided in each case where a harvesting or other treatment of the plant is required. All other apparatus can be arranged with a comparatively small spacing or directly adjacent one another.

In the embodiment shown in accordance with FIG. 1, such a spacing is shown between the apparatus A and B. It is generally naturally also conceivable that a plurality of persons are simultaneously active in the region so that also more than one such spacing can be provided or set between a respective two of the apparatus.

FIG. 3 shows the arrangement in accordance with FIG. 1 in a side view and again illustrates the spacings of the apparatus A and B.

As stated, this spacing can be enlarged and reduced. Once the harvesting of the apparatus B has ended, the apparatus A and B can again be pushed together or the apparatus B can be displaced to the left so that then a spacing exists between the apparatus B and C, etc.

In the embodiment in accordance with FIG. 2, the apparatus A, B and C as well as also the further apparatus shown each comprise one piece.

It is generally also conceivable to place a plurality of these apparatus next to one another in the longitudinal direction if this is required for the desired purpose. This can be of advantage, for example, when different plants should be provided in a row which optionally require different liquid fertilizers or other conditions such as also a different size of the container 80.

1. An apparatus for cultivating one or more plants comprising,
at least one first chamber and at least one second chamber which are separated from one another by at least one first partition wall, wherein the inner spaces of the first chamber and of the second chamber are connected by one or more connection openings in the first partition wall, and wherein the first partition wall is movable relative to the first chamber and the second chamber so that the inner spaces of the first chamber and of the second chamber are changeable upon movement of the first partition wall.

2. An apparatus in accordance with claim 1, wherein the second chamber has one or more outlet opening(s) which are arranged in at least one second partition wall which bounds the second chamber at least regionally.

3. An apparatus in accordance with claim 1, wherein the first partition wall is pivotable, displaceable or deformable.

4. An apparatus in accordance with claim 1, wherein the first partition wall is indirectly or directly connected to at least one separator, the separator being connected to a section of the apparatus which is located beneath the first partition wall.

5. An apparatus in accordance with claim 1, wherein the apparatus has at least one first side wall which comprises a flexible material.

6. An apparatus in accordance with claim 1, wherein the apparatus has at least one first side wall which comprises a material which can be rolled up or wound up.

7. An apparatus in accordance with claim 2, wherein the apparatus has at least one second side wall which is directly or indirectly connected to the second partition wall.

8. An apparatus in accordance with claim 1, wherein the apparatus has at least one first side wall and at least one second side wall which form outer surfaces of the apparatus.

9. An apparatus in accordance with claim 1, wherein at least one plant is arranged in the apparatus such that the roots of the plant are located exclusively or predominantly in the first chamber and the region of the plant bearing the crop is located exclusively or predominantly in the second chamber.

10. An apparatus in accordance with claim 1, wherein at least one plant is arranged in the apparatus such that at least one container or holder for fixing the plant is located in the at least one connection opening of the first partition wall.

11. An apparatus in accordance with claim 1, wherein at least one plant is arranged in the apparatus such that the stem of the plant extends through the at least one outlet opening of the second partition wall and the leaves of the plant are located at least in part above the second partition wall and outside the second chamber.

12. An apparatus in accordance with claim 1, wherein water and/or nutrients are present in the first chamber and/or in the second chamber.

13. An apparatus in accordance with claim 1, wherein the second chamber extends at least regionally above the first chamber.

14. An apparatus in accordance with claim 1, wherein the apparatus has an elongate extent in cross-section.

15. An arrangement including a plurality of apparatuses for cultivating one or more plants in accordance with claim 1, wherein the apparatuses are arranged such that the distance from one to another is changeable.

16. An arrangement in accordance with claim 15, wherein the apparatuses are arranged in rows, with the spacing of the rows from one another being changeable.

17. An arrangement in accordance with claim 15, wherein the apparatuses are connected to a suspension, wherein the suspension allows relative movement and change of distance between the apparatuses.

18. A method of cultivating one or more plants in an apparatus in accordance with claim 1, comprising the step-wise or continuous enlargement of the volume of the second chamber.

19. A method in accordance with claim 18, wherein the enlargement of the volume of the second chamber takes place by changing the position of the first partition wall.

20. A method of harvesting the crop of one or more plants in an apparatus in accordance with claim 1, comprising the step of the at least sectional pivoting, displacing or removing of at least one boundary surface of the second chamber and the removal of the crop from the second chamber, wherein this step is optionally preceded by the enlargement of the spacing of at least two of the apparatus.

21. An apparatus in accordance with claim 2, wherein the at least one second partition wall bounds the second chamber at least regionally at its upper side.

22. An apparatus in accordance with claim 1, wherein the first partition wall is indirectly or directly connected to at least one separator, the separator being a further partition wall between the first chamber and the second chamber.

23. An apparatus in accordance with claim 5, wherein at least one of height, length or width of the at least one first side wall is changeable.

24. An apparatus in accordance with claim 6, wherein the material is a film.

25. An apparatus in accordance with claim 6, wherein the material is selected from the group consisting of plastic or fabric.

26. An apparatus in accordance with claim 7, wherein the at least second side wall is connected to the second partition wall in a shape-matched manner.

27. An apparatus in accordance with claim 8, wherein the at least one first side wall and the at least one second side wall are connected to one another.

28. An apparatus in accordance with claim 12 further comprising means for supplying water or nutrients or water and nutrients to the first chamber or the second chamber or both chambers.

29. An apparatus in accordance with claim 13, wherein the second chamber extends at least regionally next to the first chamber.

30. An apparatus in accordance with claim 1, wherein the apparatus has a cross-section which is rectangular, square or trough-shaped.

31. An arrangement in accordance with claim 17, wherein the suspension includes a support structure having rollers, rails or guides, which operate to allow the relative movement.

32. An arrangement in accordance with claim 31, wherein the apparatuses are arranged in rows and the suspension allows the rows to be moved relative to one another.
